(19) United States
(12) Patent Application Publication
(10) Pub. No.: US 2023/0268689 A1
(43) Pub. Date: Aug. 24, 2023

(54) MULTIFUNCTIONAL CONNECTOR AND SPLICING MODEL

(71) Applicants: NONGCHANG GUO, Xianyang (CN); YUTONG LI, Qingdao (CN)

(72) Inventors: NONGCHANG GUO, Xianyang (CN); YUTONG LI, Qingdao (CN)

(21) Appl. No.: 17/693,435

(22) Filed: Mar. 14, 2022

(30) Foreign Application Priority Data
Jan. 27, 2022 (CN) 2022202280736

(51) Int. Cl. H01R 13/631; H01R 13/405; H01R 24/76; H01R 24/66; H01R 13/506

(52) U.S. Cl. CPC H01R 13/631; H01R 13/405; H01R 13/506; H01R 24/66; H01R 24/76

(57) ABSTRACT

The present disclosure provides a multifunctional connector and a splicing model. The multifunctional connector includes a first connection assembly and a second connection assembly. The first connection assembly includes a first housing, a first elastic member, and a first electrical member; wherein the first housing is hollow; the first elastic member is resiliently connected to the first housing; the first electrical member is arranged in an interior of the first housing. The second connection assembly includes a second housing, a second elastic member, and a second electrical member; wherein the second housing is hollow; the second elastic member is resiliently connected to the second housing; the second electrical member is arranged in an interior of the second housing. When the first housing is connected to the second housing, the first electrical member and the second electrical member are plugged and connected.

### CROSS-REFERENCE TO RELATED APPLICATION

The present application claims foreign priority of China Patent Application No. 202220228073.6, filed on Jan. 27, 2022, in the China National Intellectual Property Administration, the entire contents of which are hereby incorporated by reference.

### TECHNICAL FIELD

The present disclosure relates to the field of multifunctional connector technologies, and in particular to a multifunctional connector and a splicing model.

### BACKGROUND

In the production and assembly process of large Christmas tree lamps and lanterns crafts, considering the cost factors such as production, packaging and transportation convenience, manufacturers are doing bulk assembly (KD structure) of the hardware trunk iron pipe. Therefore, a structural and electrical multifunctional connecting device is needed to connect the sections of the hardware trunk iron pipes in order to assemble into a complete Christmas tree trunk and keep the upper and lower electrical connection.

Conventionally, a male and female terminal connection is applied. When a consumer assembles the upper and lower sections of the Christmas tree trunk iron pipes, the positive and negative electrodes of the male and female terminals are required to be aligned in a fixed direction before they can be connected. If there is a deviation, it will lead to damage to the terminals within the multifunctional connector, or the positive and negative polarity of the power supply is reversed, such that the charging may not be achieved or the lamps may be damaged, affecting the consumer’s experience.

### SUMMARY OF THE DISCLOSURE

The present disclosure provides a multifunctional connector and a splicing model to solve the technical problem that the existing multifunctional connector is easily damaged.

The present disclosure provides a multifunctional connector, comprising: a first connection assembly, comprising a first housing, a first elastic member, and a first electrical member; wherein the first housing is hollow; the first elastic member is resiliently connected to the first housing; the first electrical member is arranged in an interior of the first housing; and a second connection assembly, comprising a second housing, a second elastic member, and a second electrical member; wherein the second housing is hollow; the second elastic member is resiliently connected to the second housing; the second electrical member is arranged in an interior of the second housing; wherein when the first housing is connected to the second housing, the first electrical member and the second electrical member are plugged and connected.

In some embodiments, the first elastic member is arranged inside the first housing; the first housing defines a first perforation, and at least a portion of the first elastic member is movably penetrated in the first perforation and protrudes from an outer side wall of the first housing; the second elastic member is arranged in the second housing; the second housing defines a second perforation, and at least a portion of the second elastic member is movably penetrated in the second perforation and protrudes from an outer wall of the second housing.

In some embodiments, the first elastic member comprises a first shrapnel, a second shrapnel, and a first protrusion; the first shrapnel and the second shrapnel are bent and connected, the second shrapnel abuts against a side wall of the first housing, and the first protrusion is arranged on a side of the first shrapnel back from the second shrapnel and is movably penetrated into the first perforation; the second elastic member comprises a third shrapnel, a fourth shrapnel, and a second protrusion; the third shrapnel and the fourth shrapnel are bent and connected, the fourth shrapnel abuts against a side wall of the second housing, and the second protrusion is arranged on a side of the third shrapnel back from the fourth shrapnel and is movably penetrated into the second perforation.

In some embodiments, the first shrapnel is completely affixed to an inner side wall of the first housing, and an included angle between the first shrapnel and the second shrapnel is acute; the third shrapnel is completely affixed to an inner wall of the second housing, and an included angle between the fourth shrapnel and the third shrapnel is acute.

In some embodiments, a first limiting block is arranged on an inner side wall of the first housing, and the first limiting block is enclosed to define a first limiting slot; the first shrapnel and the second shrapnel are arranged in the first limiting slot; a second limiting block is arranged on an inner side wall of the second housing, and the second limiting block is enclosed to define a second limiting slot; the third shrapnel and the fourth shrapnel are arranged in the second limiting slot.

In some embodiments, the first electrical member comprises a first terminal block and a male terminal; the male terminal is arranged inside the first terminal block, and an outer wall of the male terminal is spaced from an inner wall of the first terminal block; the second electrical member comprises a second terminal block and a female terminal; the female terminal is arranged inside the second terminal block; when the male terminal and the female terminal are mated, the second terminal block is inserted in an interval between the first terminal block and the male terminal.

In some embodiments, the male terminal is arranged in the center of the first housing, and the male terminal has a circular cross-section; the female terminal is arranged in the center of the second housing, and the female terminal has a circular cross-section.

In some embodiments, the first connection assembly further comprises a first socket arranged in the first housing and electrically connected to the first electrical member; the second connection assembly further comprises a second socket arranged in the second housing and electrically connected to the second electrical member.

In some embodiments, a first surface of the first housing is docked with a second surface of the second housing; one of the first surface and the second surface is arranged with a tab, and the other of the first surface and the second surface defines a recess; the tab is inserted in the recess.

Another aspect of the present disclosure provides a splicing model, comprising: a first model, a second model, and a multifunctional connector as described above; wherein the first connection assembly is arranged inside the first model, the first elastic member is snap-connected to the first model, the second connection assembly is arranged inside the second model, and the second elastic member is snap-connected to the second model.

The beneficial effects of the present disclosure are as follows:

In the present disclosure, the first electrical member is arranged inside the first housing and the second electrical member is arranged inside the second housing. When the first housing is connected to the second housing, the first electrical member and the second electrical member are plugged and connected, such that it is possible to prevent the problem of damage caused by the need for alignment when using positive and negative electrodes to connect. In this way, it may be easy to connect the first connection assembly and the second connection assembly, saving labor costs, improving production efficiency capacity, reducing the possibility of damage to the first connection assembly and the second connection assembly, and reducing product costs.

### BRIEF DESCRIPTION OF THE DRAWINGS

To illustrate the technical solutions more clearly in the embodiments of the present disclosure, the following will be briefly described in the description of the embodiments required to use the attached drawings. It is obvious that the following description of the attached drawings are only some of the embodiments of the present disclosure, and those skilled in the art, without creative work, can also obtain other attached drawings based on these drawings.

FIG. 1 is a structural schematic view of a multifunctional connector according to an embodiment of the present disclosure.

FIG. 2 is an exploded structural schematic view of the multifunctional connector in FIG. 1.

FIG. 3 is a cross-sectional structural schematic view of the multifunctional connector in FIG. 1.

FIG. 4 is a structural schematic view of a splicing model according to an embodiment of the present disclosure.

FIG. 5 is an exploded structural schematic view of the splicing model in FIG. 4.

### DETAILED DESCRIPTION

The technical solutions in the embodiments of the present disclosure will be clearly and completely described below in conjunction with the accompanying drawings in the embodiments of the present disclosure. It will be understood that the specific embodiments described herein are for the purpose of explaining the present disclosure only, and not for the purpose of limiting the present disclosure. It should also be noted that, for the sake of description, only some but not all structures related to the present disclosure are shown in the attached drawings. Based on the embodiment of the present disclosure, all other embodiments obtained by those skilled in the art without creative work fall within the scope of the present disclosure.

References to “embodiments” in this document mean that a particular feature, structure or characteristic described in connection with an embodiment may be included in at least one embodiment of the present disclosure. The presence of the phrase in various places in the specification does not necessarily mean the same embodiment, nor is it a separate or alternative embodiment that is mutually exclusive with other embodiments. It is understood, both explicitly and implicitly, by those skilled in the art that the embodiments described herein may be combined with other embodiments.

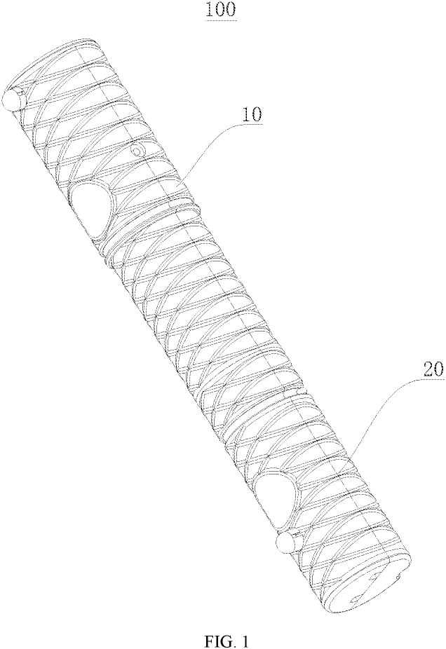

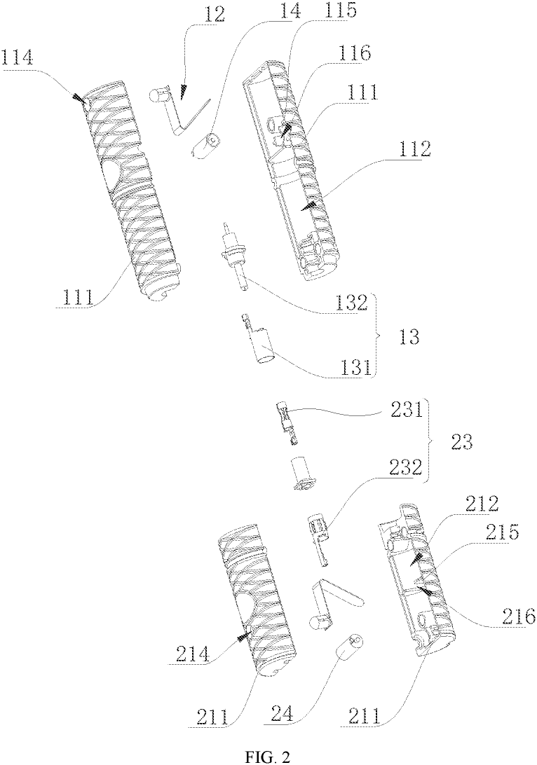

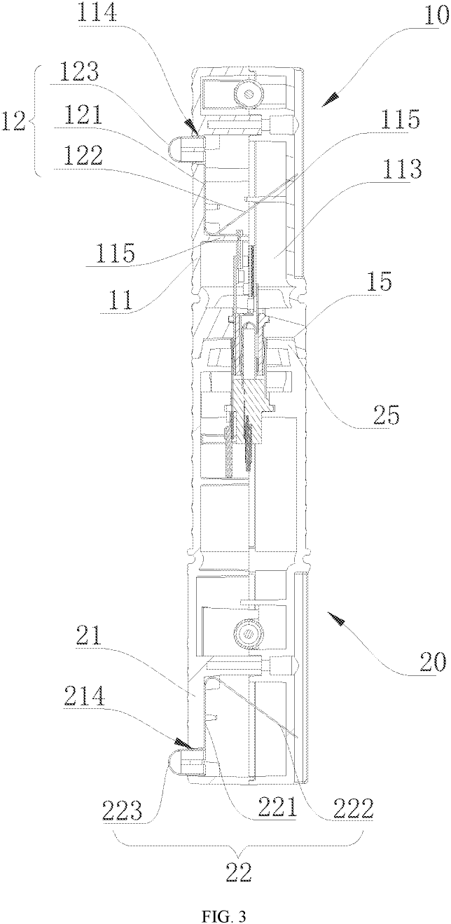

Referring to FIGS. 1 to 3, FIG. 1 is a structural schematic view of a multifunctional connector according to an embodiment of the present disclosure, FIG. 2 is an exploded structural schematic view of the multifunctional connector in FIG. 1, and FIG. 3 is a cross-sectional structural schematic view of the multifunctional connector in FIG. 1. The present disclosure provides a multifunctional connector 100 including a first connection assembly 10 and a second connection assembly 20.

The first connection assembly 10 includes a first housing 11, a first elastic member 12, and a first electrical member 13. The first housing 11 is hollow. The first elastic member 12 is resiliently connected to the first housing 11. The first electrical member 13 is arranged in an interior of the first housing 11. The second connection assembly 20 includes a second housing 21, a second elastic member 22, and a second electrical member 23. The second housing 21 is hollow. The second elastic member 22 is resiliently connected to the second housing 21. The second electrical member 23 is arranged in an interior of the second housing 21. When the first housing 11 is connected to the second housing 21, the first electrical member 13 and the second electrical member 23 are plugged and connected.

In the present disclosure, the first electrical member 13 is arranged inside the first housing 11 and the second electrical member 23 is arranged inside the second housing 21. When the first housing 11 is connected to the second housing 21, the first electrical member 13 and the second electrical member 23 are plugged and connected, such that it is possible to prevent the problem of damage caused by the need for alignment when using positive and negative electrodes to connect. In this way, it may be easy to connect the first connection assembly 10 and the second connection assembly 20, saving labor costs, improving production efficiency capacity, reducing the possibility of damage to the first connection assembly 10 and the second connection assembly 20, and reducing product costs.

In some embodiments, the first housing 11 and the second housing 21 may be made of materials such as plastic by injection molding, or, the first housing 11 and the second housing 21 may be made of materials such as alloy.

As shown in FIG. 2, the first housing 11 may include two first sub-housings 111 that can be removably connected. For each first sub-housing 111, a first capacitance slot 112 is defined on a surface of the first sub-housing 111 facing the other first sub-housing 111. When the two first sub-housings 111 are snapped together, the first capacitance slots 112 of the two first sub-housings 111 are aligned with each other and enclosed to define a first capacitance cavity 113. The first electrical member 13 housed in the first capacitance cavity 113.

In some embodiments, the two first sub-housings 111 may be connected by fasteners such as screws, or the two first sub-housings 111 may be connected by means of a snap and a snap hook for snap connection.

Similarly, as shown in FIG. 2, the second housing 21 may include second sub-housings 211 that can be two removably connected. For each second sub-housing 211, a second capacitance slot 212 is defined on a surface of the second sub-housing 211 facing the other second sub-housing 211. When the two second sub-housings 211 are snapped together, the second capacitance slots 212 of the two second sub-housings 211 are aligned with each other and enclosed to define a second capacitance cavity 213. The second electrical member 23 is housed in the second capacitance cavity 213.

In some embodiments, the two second sub-housings 211 may be connected by fasteners such as screws, or the two second sub-housings 211 may be connected by means of a snap and a snap hook for snap connection.

Among them, the first elastic member 12 arranged on the first housing 11 is connected to snap the first housing 11 to an external component, and the second elastic member 22 arranged on the second housing 21 is configured to snap the second housing 21 to an external component.

In the embodiments, as shown in FIGS. 2 and 3, the first elastic member 12 is arranged inside the first housing 11. The first housing 11 defines a first perforation 114, and at least a portion of the first elastic member 12 is movably penetrated in the first perforation 114 and protrudes from an outer side wall of the first housing 11. The second elastic member 22 is arranged in the second housing 21. The second housing 21 defines a second perforation 214, and at least a portion of the second elastic member 22 is movably penetrated in the second perforation 214 and protrudes from an outer wall of the second housing 21.

By arranging the first elastic member 12 inside the first housing 11, the connection of the first housing 11 with the external component may be tighter. By arranging the second elastic member 22 inside the second housing 21, the connection of the second housing 21 with the (other) external component may be tighter.

Further, as shown in FIGS. 2 and 3, the first elastic member 12 includes a first shrapnel 121, a second shrapnel 122, and a first protrusion 123. The first shrapnel 121 and the second shrapnel 122 are bent and connected, the second shrapnel 122 abuts against a side wall of the first housing 11, and the first protrusion 123 is arranged on a side of the first shrapnel 121 back from the second shrapnel 122 and is movably penetrated into the first perforation 114.

Specifically, the first elastic member 12 is made of metal or alloy. The first shrapnel 121 and the second shrapnel 122 may be arranged as a one-piece structure formed by bending a metal in the form of a sheet, such that the production process of the first elastic member 12 may be simplified and thus improve the production efficiency of the first elastic member 12.

An end of the first shrapnel 121 and an end of the second shrapnel 122 facing away from each other abut against two opposite side walls of the first capacitance cavity 113. The first protrusion 123 is arranged on the first shrapnel 121 and is movably penetrated into the first perforation 114. The first shrapnel 121 may move inwardly when the first shrapnel 123 is contracted inwardly by an external compression. When the external compression disappears, the elastic force of the second shrapnel 122 on the first shrapnel 121 drives the first shrapnel 121 to drive the first protrusion 123 to move, such that the first protrusion 123 protrudes from the outer wall of the first housing 11 to be configured to engage with the external component.

As can be understood, as shown in FIGS. 2 and 3, the second elastic member 22 includes a third shrapnel 221, a fourth shrapnel 222, and a second protrusion 223. The third shrapnel 221 and the fourth shrapnel 222 are bent and connected. The fourth shrapnel 222 abuts against a side wall of the second housing 21, and the second protrusion 223 is arranged on a side of the third shrapnel 221 back from the fourth shrapnel 222 and is movably penetrated into the second perforation 214.

Further, the first shrapnel 121 is completely affixed to an inner side wall of the first housing 11. In this way, the contact area between the first shrapnel 121 and the first housing 11 may be increased. In addition, since the axial direction of the first perforation 114 is perpendicular to the inner side wall of the first housing 11, by arranging the first shrapnel 121 completely affixed to the inner side wall of the first housing 11 may make the axial direction of the first perforation 114 perpendicular to a plane in which the first shrapnel 121 is located. Therefore, the first shrapnel 121 may be prevented from being subjected to a force along the axial direction of the first housing 11, and the first elastic member 12 may be prevented from being displaced along the axial direction of the first housing 11.

Among them, an included angle between the first shrapnel 121 and the second shrapnel 122 may be arranged as an acute angle. In this way, when the first protrusion 123 is contracted inwardly by the external force, the included angle between the first shrapnel 121 and the second shrapnel 122 may be reduced, increasing the reaction force of the second shrapnel 122 on the first shrapnel 121. Further, when the external force disappears, the second shrapnel 122 may quickly reset the first shrapnel 121.

In some embodiments, the included angle between the first shrapnel 121 and the second shrapnel 122 may be arranged as an obtuse angle. In this case, the second shrapnel 122 may also exert force on the first shrapnel 121.

It can be understood that the third shrapnel 221 may be completely affixed to an inner wall of the second housing 21, and an included angle between the fourth shrapnel 222 and the third shrapnel 221 is an acute angle.

Since the first protrusion 123 will move under the action of external force, the first elastic member 12 will inevitably move when used for a long time. To enhance the structural stability of the first elastic member 12, as shown in FIGS. 2 and 3, a first limiting block 115 may be arranged on the inner side wall of the first housing 11, and the first limiting block 115 is enclosed to define a first limiting slot 116. The first shrapnel 121 and the second shrapnel 122 are arranged in the first limiting slot 116. In this way, by setting the first elastic member 12 in the first limiting slot 116, the first elastic member 12 may be positionally limited by the first limiting slot 116 to prevent the first elastic member 12 from being displaced, such that the first protrusion 123 may not move out from the first perforation 114.

In a similar manner, a second limiting block 215 is arranged on the inner side wall of the second housing 21, and the second limiting block 215 is enclosed to define a second limiting slot 216. The third shrapnel 221 and the fourth shrapnel 222 are arranged in the second limiting slot 216.

In some embodiments, the first limiting block 115 and the first housing 11 may be set as a one-piece structure, i.e., a one-piece first limiting block 115 and first housing 11 may be prepared by injection molding, such that the number of components may be reduced, and the assembly efficiency may be improved.

Further, the first limiting block 115 may be set as a one-piece annular structure; or the first limiting block 115 may include a plurality of sub-limiting blocks arranged at intervals, and the plurality of sub-limiting blocks are collectively enclosed to define the first limiting slot 116. The present disclosure does not specifically limit the number of the first limiting blocks 115.

In some embodiments, as shown in FIGS. 2 and 3, the first electrical member 13 includes a first terminal block 131 and a male terminal 132. The male terminal 132 is arranged inside the first terminal block 131, and an outer wall of the male terminal 132 is spaced from an inner wall of the first terminal block 131. The second electrical member 23 includes a second terminal block 231 and a female terminal 232. The female terminal 232 is arranged inside the second terminal block 231. When the male terminal 132 and the female terminal 232 are mated, the second terminal block 231 is inserted in an interval between the first terminal block 131 and the male terminal 132. In this way, by keeping the second terminal block 231 within the interval between the first terminal block 131 and the male terminal 132, the connection of the first electrical member 13 and the second electrical member 23 may be tighter.

Further, as shown in FIGS. 2 and 3, the male terminal 132 is arranged in the center of the first housing 11, and the male terminal 132 has a circular cross-section. The female terminal 232 is arranged in the center of the second housing 21, and the female terminal 232 has a circular cross-section. In this way, by virtue of the use of internal and external circular first housing 11 and second housing 21, and the male terminal 132 and female terminal 232 being arranged in the center of the first housing 11 and second housing 21, respectively, consumers do not have to consider the fixed direction of assembly when assembling, but directly insert the first housing 11 and the second housing 21 for subsequent use. They do not need to worry about the positive and negative poles inserted backwards, which is convenient for consumers to use. The consumers can complete the connection of the first electrical member 13 and the second electrical member 23 by 360° docking without dead-end in the installation phase for proper powering.

Further, as shown in FIGS. 2 and 3, the first connection assembly 10 further includes a first socket 14 arranged in the first housing 11 and electrically connected to the first electrical member 13. The second connection assembly 20 further includes a second socket 24 arranged in the second housing 21 and electrically connected to the second electrical member 23.

Since the first socket 14 is electrically connected to the first electrical member 13 and the second socket 24 is electrically connected to the second electrical member 23, it is possible to electrically connect the first socket 14 and the second socket 24 by the electrical connection of the first electrical member 13 and the second electrical member 23. The multifunctional connector 100 can supply power to the external component when the external component is connected to the first socket 14 or the second socket 24.

Further, as shown in FIG. 3, a recess 15 may be defined on a surface of the first housing 11 docked with the second housing 21, and a tab 25 is arranged on a surface of the second housing 21 docked with the first housing 11. The tab 25 is inserted in the recess 15. By the cooperation of the tab 25 and the recess 15, the first housing 11 and the second housing 21 may be positioned along a radial direction of the multifunctional connector 100 to prevent damage to the first electrical member 13 and the second electrical member 23 due to relative movement of the first housing 11 and the second housing 21 when they are subjected to a force along the radial direction.

In some embodiments, the recess 15 may be defined around a circumference of the first housing 11 and the tab 25 may be arranged around a circumference of the second housing 21. In this way, when the tab 25 and the recess 15 cooperate, a sealing structure may be arranged around a periphery of the first electrical member 13 and the second electrical member 23 to prevent external water vapor and the like from entering the interior of the first housing 11 and the second housing 21 and damaging the first electrical member 13 and the second electrical member 23.

In other embodiments, a tab 25 is arranged on a surface of the first housing 11 docked with the second housing 21, and a recess 15 is defined on a surface of the second housing 21 docked with the first housing 11. The tab 25 is inserted in the recess 15.

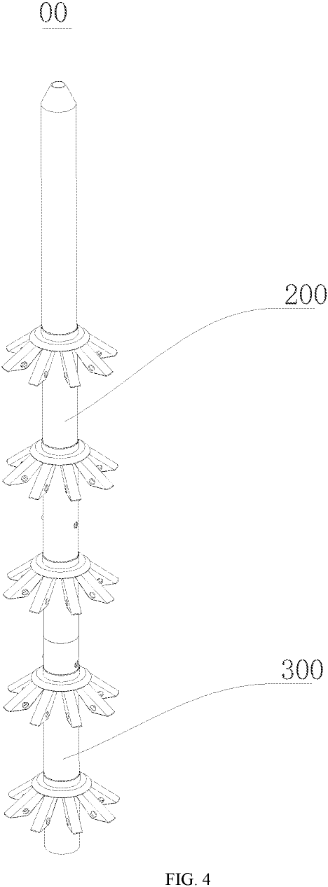

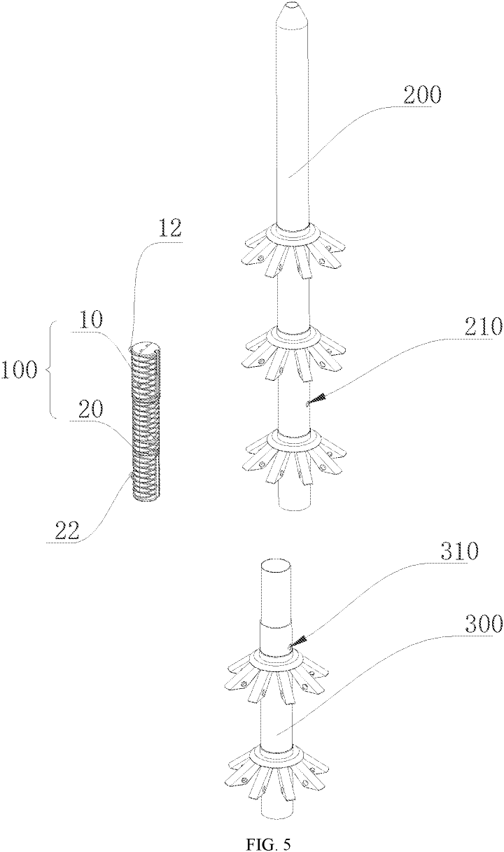

Further, as shown in FIGS. 4 and 5, FIG. 4 is a structural schematic view of a splicing model according to an embodiment of the present disclosure, and FIG. 5 is an exploded structural schematic view of the splicing model in FIG. 4. Another aspect of the present disclosure provides a splicing model 00 including a first model 200, a second model 300, and a multifunctional connector 100. A first connection assembly 10 is arranged inside the first model 200, a first elastic member 12 is snap-connected to the first model 200, a second connection assembly 20 is arranged inside the second model 300, and a second elastic member 22 is snap-connected to the second model 300.

The first model 200 and the second model 300 may be Christmas tree models. A conventional Christmas tree model is connected to a connector through a screw nut. It is necessary to align 2 holes of the Christmas tree model with through holes of the connector, insert the screw into them, and lock the nut, such that the connector can be fixed in the middle of the Christmas tree model. In practice, this method will lead to high assembly cost and low production efficiency because it is not easy to align the holes and the operation steps are tedious, and the nut fixing is easy to loosen and fall off.

While in the embodiment of the present disclosure, the first model 200 is snap-connected to the first connection assembly 10, and the second model 300 is snap-connected to the second connection assembly 20. When the first connection assembly 10 and the second connection assembly 20 are connected, the first model 200 and the second model 300 can also be connected to each other. In this way, the connection complexity of the first model 200 and the second model 300 may be simplified and the connection efficiency of the first model 200 and the second model 300 may be improved.

Specifically, a first assembly hole 210 is defined on the first model 200. When assembling the multifunctional connector 100 with the first model 200, a first protrusion 123 on the first connection assembly 10 contracts inward under the force of the resisting pressure of the first model 200, such that the first connection assembly 10 can enter the interior of the first model 200 and move along an axial direction of the first model 200. When the first protrusion 123 moves to the position of the first assembly hole 210, the force of the first model 200 on the first protrusion 123 disappears, and the first protrusion 123 extends outwardly under the action of a second shrapnel 122 and is inserted inside the first assembly hole 210 to connect the first model 200 to the first connection assembly 10.

Further, a second assembly hole 310 is defined on the second model 300, and the multifunctional connector 100 may be snap-connected to the second model 300 in a similar manner. In addition, since the first electrical member 13 and the second electrical member 23 are electrically connected to each other, it is possible to electrically connect light strings on the first model 200 and the second model 300 to each other.

The above are only embodiments of the present disclosure and not intended to limit the scope of the present disclosure. Any equivalent structure or equivalent process transformation made by using the contents of the specification and the accompanying drawings of the present disclosure or applied directly or indirectly in other related technical fields, is included in the scope of the present disclosure in the same way.

What is claimed is:

1. A multifunctional connector, comprising:
a first connection assembly, comprising a first housing, a first elastic member, and a first electrical member; wherein the first housing is hollow; the first elastic member is resiliently connected to the first housing; the first electrical member is arranged in an interior of the first housing; and
a second connection assembly, comprising a second housing, a second elastic member, and a second electrical member; wherein the second housing is hollow; the second elastic member is resiliently connected to the second housing; the second electrical member is arranged in an interior of the second housing;
wherein when the first housing is connected to the second housing, the first electrical member and the second electrical member are plugged and connected.

2. The multifunctional connector according to claim 1, wherein the first elastic member is arranged inside the first housing; the first housing defines a first perforation, and at least a portion of the first elastic member is movably penetrated in the first perforation and protrudes from an outer side wall of the first housing;
the second elastic member is arranged in the second housing; the second housing defines a second perforation, and at least a portion of the second elastic member is movably penetrated in the second perforation and protrudes from an outer wall of the second housing.

3. The multifunctional connector according to claim 2, wherein the first elastic member comprises a first shrapnel, a second shrapnel, and a first protrusion; the first shrapnel and the second shrapnel are bent and connected, the second shrapnel abuts against a side wall of the first housing, and the first protrusion is arranged on a side of the first shrapnel back from the second shrapnel and is movably penetrated into the first perforation;
the second elastic member comprises a third shrapnel, a fourth shrapnel, and a second protrusion; the third shrapnel and the fourth shrapnel are bent and connected, the fourth shrapnel abuts against a side wall of the second housing, and the second protrusion is arranged on a side of the third shrapnel back from the fourth shrapnel and is movably penetrated into the second perforation.

4. The multifunctional connector according to claim 3, wherein the first shrapnel is completely affixed to an inner side wall of the first housing, and an included angle between the first shrapnel and the second shrapnel is acute;
the third shrapnel is completely affixed to an inner wall of the second housing, and an included angle between the fourth shrapnel and the third shrapnel is acute.

5. The multifunctional connector according to claim 3, wherein a first limiting block is arranged on an inner side wall of the first housing, and the first limiting block is enclosed to define a first limiting slot; the first shrapnel and the second shrapnel are arranged in the first limiting slot;
a second limiting block is arranged on an inner side wall of the second housing, and the second limiting block is enclosed to define a second limiting slot; the third shrapnel and the fourth shrapnel are arranged in the second limiting slot.

6. The multifunctional connector according to claim 1, wherein the first electrical member comprises a first terminal block and a male terminal; the male terminal is arranged inside the first terminal block, and an outer wall of the male terminal is spaced from an inner wall of the first terminal block;
the second electrical member comprises a second terminal block and a female terminal; the female terminal is arranged inside the second terminal block;
when the male terminal and the female terminal are mated, the second terminal block is inserted in an interval between the first terminal block and the male terminal.

7. The multifunctional connector according to claim 6, wherein the male terminal is arranged in the center of the first housing, and the male terminal has a circular cross-section; the female terminal is arranged in the center of the second housing, and the female terminal has a circular cross-section.

8. The multifunctional connector according to claim 1, wherein the first connection assembly further comprises a first socket arranged in the first housing and electrically connected to the first electrical member;
the second connection assembly further comprises a second socket arranged in the second housing and electrically connected to the second electrical member.

9. The multifunctional connector according to claim 1, wherein a first surface of the first housing is docked with a second surface of the second housing; one of the first surface and the second surface is arranged with a tab, and the other of the first surface and the second surface defines a recess; the tab is inserted in the recess.

10. A splicing model, comprising: a first model, a second model, and a multifunctional connector;
wherein the multifunctional connector comprises:
a first connection assembly, comprising a first housing, a first elastic member, and a first electrical member; wherein the first housing is hollow; the first elastic member is resiliently connected to the first housing; the first electrical member is arranged in an interior of the first housing; and
a second connection assembly, comprising a second housing, a second elastic member, and a second electrical member; wherein the second housing is hollow; the second elastic member is resiliently connected to the second housing; the second electrical member is arranged in an interior of the second housing;
wherein when the first housing is connected to the second housing, the first electrical member and the second electrical member are plugged and connected;
the first connection assembly is arranged inside the first model, the first elastic member is snap-connected to the first model, the second connection assembly is arranged inside the second model, and the second elastic member is snap-connected to the second model.
